(19) United States
(12) Patent Application Publication
(10) Pub. No.: US 2010/0315260 A1
(43) Pub. Date: Dec. 16, 2010

(54) PASSENGER GUIDANCE DEVICE, PASSENGER GUIDANCE METHOD AND ASSOCIATED POSITIONING SYSTEM

(75) Inventors: Dieter Geiger, Korntal-Muenchingen (DE); Paul Mathias, Aachen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, DE (unknown)

(21) Appl. No.: 12/866,117

(22) PCT Filed: Jan. 28, 2009
(86) PCT No.: PCT/EP2009/050927

§ 371 Date: Aug. 4, 2010

(30) Foreign Application Priority Data
Feb. 4, 2008 (DE) 10 2008 007 471.3

(51) Int. Cl. G08B 5/22

(52) U.S. Cl. 340/825.49

(57) ABSTRACT

A passenger guidance method includes the following steps: receiving a signal that is transmitted by a transmitter and that has an identifier; calculating a position of the transmitter using the signal; and outputting the position information to the transmitter. A passenger guidance method is provided which helps the driver of a motor vehicle find his or her parked motor vehicle. To method includes a step of identifying the transmitter before outputting the position information for that purpose.

The present invention relates to a person guidance apparatus according to the precharacterizing clause of patent claim 1, to a position-determining device according to the precharacterizing clause of patent claim 7 and to a person guidance method according to the precharacterizing clause of patent claim 9.

Such a person guidance apparatus comprises a position output device which is set up to output position information relating to a transmitting device. The position information is supplied by a position-determining device which comprises a receiving device and an evaluation device, the receiving device being set up to receive a signal which is emitted by the transmitting device and has an identifier, and the evaluation device being set up to calculate a position of the transmitting device on the basis of the signal. The person guidance apparatus is in the form of a computer on which a program, which makes it possible to calculate the position of the transmitting device, and a program, which makes it possible to output the position information, can be executed. The transmitting device is in the form of an RFID transponder which emits the signal only after it has been activated by an activation signal. The receiving device comprises a plurality of antennas. The computer calculates the position of the RFID transponder on the basis of signal differences during reception by the different antennas.

One known use of the system is to locate new automobiles, which have left an assembly hall, prior to their delivery. In this case, an RFID transponder with a particular identifier is first of all accommodated in each of the new automobiles.

The computer stores which RFID transponder is accommodated in which new automobile. In order to locate a new automobile, a user inputs, to the computer, the new automobile which is intended to be looked for. The computer then looks for the identifier of the RFID transponder, which is provided in the new automobile being looked for, and evaluates the signal emitted by the RFID transponder with the identifier in order to locate the new automobile. Finally, the computer outputs position information relating to the new automobile being looked for.

However, such a person guidance apparatus cannot be used to lead a motor vehicle driver to his motor vehicle which has previously been parked by the driver in a parking lot since a central database which assigns a particular identifier to his motor vehicle is not present.

The present invention is based on the object of providing a person guidance apparatus, a position-determining device and a person guidance method which assist a motor vehicle driver in finding his parked motor vehicle again.

The object on which the invention is based is achieved by means of a person guidance apparatus having the features of the characterizing part of patent claim 1, a position-determining device having the features of the characterizing part of patent claim 7 and a person guidance method having the features of the characterizing part of patent claim 9.

The present invention relates to a person guidance apparatus having a position output device which is set up to output position information for the transmitting device, an identity detection device being provided in order to identify the transmitting device. In this context, “to identify” means the selection of a transmitting device, relating to which position information is intended to be output. The transmitting device is selected by the identity detection device reading an identity code on an identity card or generally an identity element which is not in the form of a card. The identity code generally corresponds to a characteristic signal and may be a digital signal, in particular. The transmitting device may or else may not be integrated in the identity card. The transmitting device is or was situated in a motor vehicle, with the result that a position of the motor vehicle can be determined from the position information relating to the transmitting device. Position information is generally any information relating to the position of the transmitting device. It may be, for example, a parking space number, information relating to a path to the motor vehicle or a map on which the position of the motor vehicle is indicated.

In one preferred embodiment, a position-determining device which has a receiving device and an evaluation device is provided, the receiving device being set up to receive a signal which is emitted by the transmitting device and has an identifier, and the evaluation device being set up to determine a position of the transmitting device on the basis of the signal. The identifier can generally match the identity code but may also differ from the identity code. In particular, the identifier and the identity code can each correspond to the same sequence of digital values. However, the identity code can generally be uniquely assigned to a particular identifier.

In an alternative preferred embodiment, an interface for receiving the position information from a position-determining device is provided. The practice of separately providing the position-determining device makes it possible to supply a plurality of person guidance apparatuses with position information from a central position-determining device.

In another preferred embodiment, the identity detection device is a chip card reading device, a magnetic strip reading device or an RFID transponder reading device. The transmitting device is an RFID transponder. Using an RFID transponder reading device for identity detection in the person guidance apparatus makes it possible to use the identifier emitted by the transmitting device to identify the transmitting device, the transmitting device being integrated in the identity card, and the identifier being identical to the identity code. However, the reading device in the person guidance apparatus has different requirements from the receiving device. Whereas the receiving device requires a strong signal, the identity detection device manages with a weak signal. Active RFID transponders which emit the signal only after they have received an activation signal are suitable for generating a strong signal. In addition, a writable memory should be present on the identity card. Said memory can be designed as a magnetic strip in a particularly cost-effective manner. The identity code can also be stored in this memory.

In another preferred embodiment, the position output device comprises at least one audio output device, a display device, a printing device or a data interface. Each of these position output devices can be provided in combination with one or more arbitrary further position output devices. The printing device can be integrated in the identity detection device, with the result that a parking space number, for example, can be printed onto the identity card when the latter is inserted into the identity detection device.

In yet another preferred embodiment, the person guidance apparatus also comprises a payment device. This makes it possible to connect the identification of the transmitting device to the payment operation in a time-saving manner. The identity card can likewise also be used for the payment operation.

The present invention also relates to a position-determining device having a receiving device and an evaluation device, the receiving device being set up to receive a signal which is emitted by a transmitting device and has an identifier, the evaluation device being set up to calculate a position of the transmitting device on the basis of the signal, and the evaluation device being set up to use map information to determine whether the position is a parked position. Since the motor vehicle driver duly parks his motor vehicle in parking spaces provided for this purpose and otherwise moves the motor vehicle outside the parking spaces, map information provides important clues with regard to whether or not the motor vehicle driver has parked the motor vehicle. If the motor vehicle driver leaves his parked motor vehicle, he can take along the transmitting device which is integrated in an identity card, for example, the evaluation device storing the parked position. The identity card can therefore be simultaneously used as a payment card, and the motor vehicle can subsequently be located using the stored parked position.

In one preferred embodiment, the evaluation device is set up to use a residence time at the position to determine whether the position is the parked position. In particular when parking, turning or driving over a parking space, the motor vehicle may reach a parking space in which it is not parked. However, the motor vehicle will then remain in a parking space only for a short period of time. In such cases, the residence time is an important criterion for determining whether the motor vehicle is parked.

The present invention also relates to a person guidance method having the following steps of: receiving a signal which is emitted by a transmitting device and has an identifier; calculating a position of the transmitting device on the basis of the signal; outputting position information relating to the transmitting device; and a step of identifying the transmitting device before outputting position information.

In one preferred embodiment, map information is used to determine whether the position is a parked position.

In one development of the preferred embodiment, a residence time at the position is used to determine whether the position is a parked position.

The invention is described in more detail below with reference to the drawings, in which:

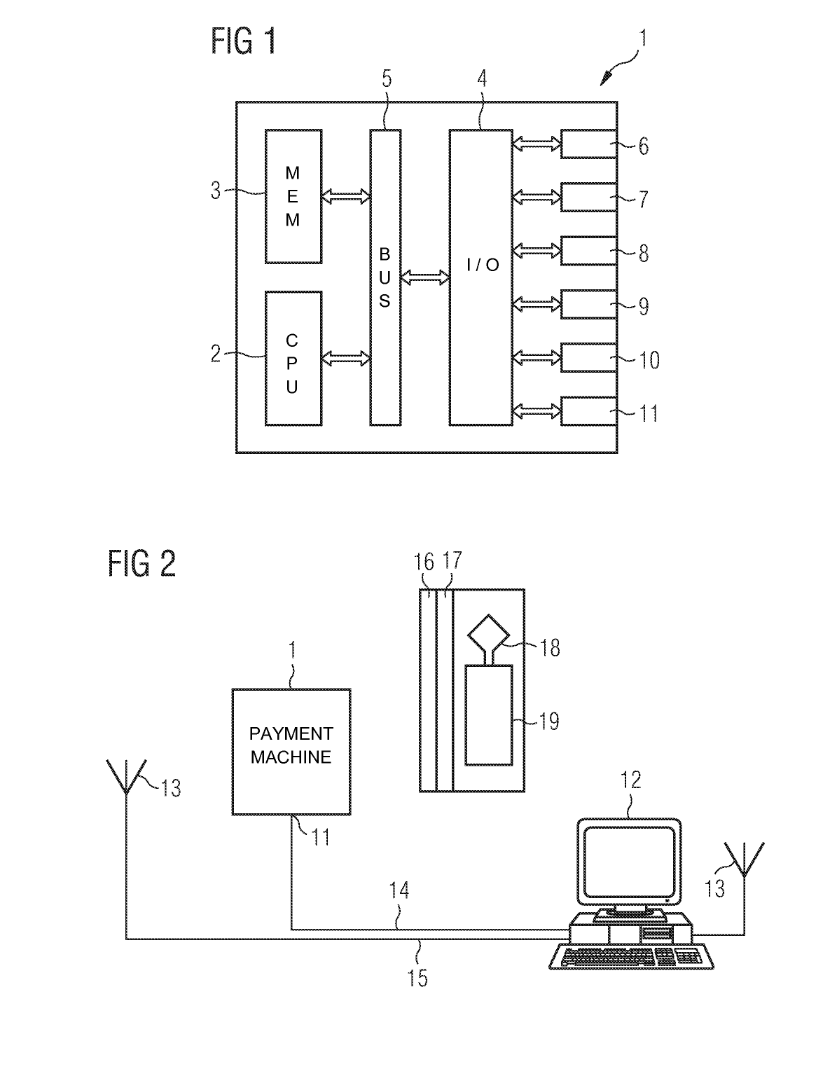

FIG. 1 shows a schematic view of a person guidance apparatus;

FIG. 2 shows a schematic view of a person guidance system; and

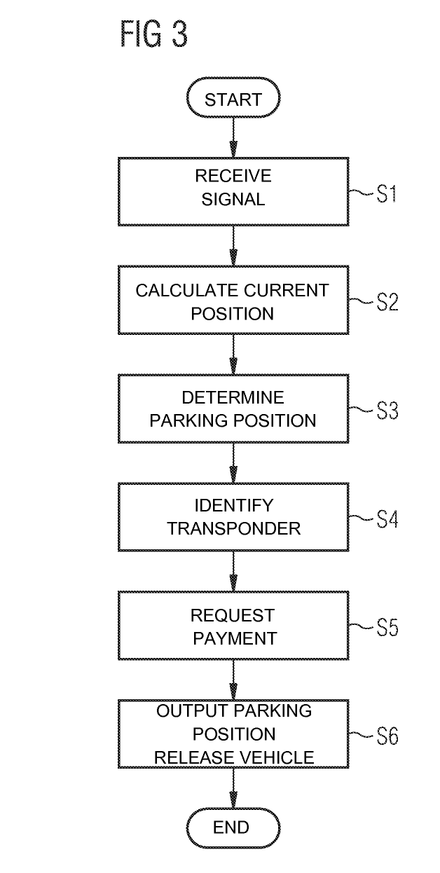

FIG. 3 shows a flowchart of a person guidance method.

FIG. 1 shows a schematic view of a person guidance apparatus which is in the form of a payment machine 1 or is integrated in a payment machine. The payment machine 1 comprises a Von-Neumann machine having a central processor 2, a main memory 3, an input/output processor 4 and connecting paths (bus) 5. The central processor 2 executes a machine program which is stored in the main memory 3. The input/output processor 4 accesses a card reading/card writing device 6, a payment device 7, an input device 8, a display device 9, a radio interface 10 for a personal digital assistant (PDA) and an interface 11 for a position-determining device. The card reading/card writing device 6 is generally set up to read an identity code of an identity card and an ejection time of the identity card. It is specifically a magnetic strip reading/magnetic strip writing device 6 which reads data on a magnetic strip or writes data to the magnetic strip. The payment device 7 has a money slot, a money return means, a money storage device and a money detection device. The input device 8 comprises a keypad which allows a user to communicate with the payment machine in order to select certain options. The display device 9 comprises an LCD screen. The radio interface 10 comprises an antenna for short-range communication with the PDA. The interface 11 is in the form of a connection for a data transmission line. The card reading/card writing device 6, the payment device 7, the input device 8, the display device 9, the radio interface 10 for the PDA and the interface 11 for the position-determining device have a known and conventional structure. Therefore, they are not described in any more detail. By contrast, their interaction according to the invention and their use according to the invention, which are determined by the machine program executed by the central processor, are not known.

FIG. 2 shows a schematic view of a person guidance system which is not true to scale and which is used to illustrate a person guidance method whose essential steps are shown in the flowchart from FIG. 3. The person guidance system comprises the payment machine 1, a position-determining device 12 which is in the form of a computer on which an evaluation program is executed, and a receiving device having a plurality of antennas 13. The payment machine 1 is connected to the computer 12 via a data transmission line 14. The computer 12 is likewise connected to the antennas 13 via data transmission lines 15. An identity card 16 comprises a magnetic strip 17. An RFID transponder with a transmitting device 18 and a microchip 19 is integrated in the identity card 16. A motor vehicle driver receives the identity card, for example when he drives a motor vehicle into a parking garage, by operating an ejection unit in front of an entrance barrier. The ejection unit stores the ejection time on the magnetic strip 17 before ejecting the identity card. The microchip 19 generates a signal which has an identifier and is emitted via the transmitting device 18. An identity code which is assigned to the identifier of the identity card is also stored on the magnetic strip 17. The computer 12 receives the signal via the antennas 13 (step S1). The computer 12 can continuously calculate the current position of the RFID transponder on the basis of signal differences during reception by the different antennas 13 (step S2). The evaluation device uses a method known from the prior art for this purpose. A digital map of the parking garage is stored on a hard disk of the computer 12. As the computer 12 determines the current position of the RFID transponder on the digital map, the computer 12 determines whether the RFID transponder is situated in a parking space. If the identity card stays in the parking space for a certain minimum residence time, the computer 12 can conclude that the motor vehicle has been parked in a parking space which is allocated a certain parking space number, and thus determines a parked position of the motor vehicle (step S3). The motor vehicle driver leaves the parked motor vehicle and takes along the identity card 16, the parked position remaining stored. If the motor vehicle driver would subsequently like to leave the parking garage with his motor vehicle, he first of all goes to the payment machine 1 and inserts the identity card 16 into the magnetic strip reading/magnetic strip writing device 6. The magnetic strip reading/magnetic strip writing device 6 reads the identity code and the ejection time of the identity card 16. The identity code and the ejection time are transmitted from the input/output processor 4 to the central processor 2 via the data bus 6. The processor determines a parking fee to be paid and forwards the identity code to the interface 11, from which the identity code is transmitted to the computer 12. The computer 12 assigns the identity code to the corresponding identifier and thus identifies the RFID transponder 16 for which the corresponding parked position is intended to be determined (step S4). The computer 12 transmits the number of the parking space together with further parked position information, such as a map section and path information relating to the parking space, to the payment machine 1 via the interface 11. The input/output processor 4 transmits the parked position information, via the data bus 6, to the central processor 2 which processes the parked position information and forwards the processed parked position information and the data relating to the parking fee to be paid to the input/output processor 4 via the data bus. The input/output processor 4 forwards the data relating to the parking fee to be paid to the payment device 7 and to the display device 9 and forwards the processed parked position information to the display device 9 and to the radio interface 10 for a personal digital assistant (PDA). The display device displays the parking space number, a map section, path information and a message for requesting the motor vehicle driver to pay a certain amount of money. The PDA can simultaneously receive the parking space number, the map section and path information via the radio interface 10. The motor vehicle driver inserts a number of coins into the payment device 7 and possibly receives change from the payment device 7. The payment device 7 now emits a signal which indicates that the parking fee has been paid. This signal is transmitted to the central processor 2. The central processor determines when the motor vehicle driver has paid the parking fee and generates corresponding payment time data which are transmitted to the magnetic strip reading/magnetic strip writing device 6. The magnetic strip reading/magnetic strip writing device 6 stores the payment time data on the magnetic strip 17. When leaving the parking garage, the motor vehicle driver inserts the identity card 16 into an insertion unit in front of an exit barrier. This unit reads the payment time data on the magnetic strip 17 and enables passage if the payment time is not longer than a particular duration.

1-15. (canceled)

16. A person guidance apparatus, comprising:
a receiving device configured to receive a signal emitted by a transmitting device and containing an identifier;
an evaluation device configured to determine a position of said transmitting device from the signal received by said receiving device, to use map information for determining whether the position is a parked position, and to store the parked position;
an identity detection device configured to identify said transmitting device after said transmitting device has been taken from the parked position; and
a position output device configured to output position information relating to the parked position after said transmitting device has been identified.

17. The person guidance apparatus according to claim 16, further comprising:
a payment machine including said identity detection device and said position output device; and
said payment machine further including an interface for receiving the position information relating to the parked position from said evaluation device.

18. The person guidance apparatus according to claim 16, wherein said identity detection device is a chip card reading device, a magnetic strip reading device, or an RFID transponder reading device.

19. The person guidance apparatus according to claim 16, wherein said position output device includes at least one audio output device, a display device, a printing device, or a data interface.

20. The person guidance apparatus according to claim 19, wherein said data interface is a radio interface for a personal digital assistant.

21. The person guidance apparatus according to claim 16, wherein said person guidance apparatus also comprises a payment device.

22. The person guidance apparatus according to claim 16, wherein said evaluation device is configured to use a residence time at the position to determine whether the position is the parked position.

23. The person guidance apparatus according to claim 16, configured to find a motor vehicle that has been parked in a parking garage, wherein the map information comprises a digital map of the parking garage.

24. The person guidance apparatus according to claim 16, wherein said transmitting device is integrated in an identity card, said identity detection device is configured to read an identity code on said identity card in order to identify the transmitting device, and the identity code is assigned to the identifier of the signal emitted by said transmitting device.

25. The person guidance apparatus according to claim 16, wherein said transmitting device is an RFID transponder.

26. A person guidance method, which comprises:
receiving a signal that is emitted by a transmitting device and that has an identifier;
determining a position of the transmitting device on the basis of the signal received from the transmitting device;
using map information to determine whether the position is a parked position;
storing the parked position;
identifying the transmitting device after the transmitting device has been taken from the parked position; and
outputting position information relating to the parked position after the transmitting device has been identified.

27. The person guidance method according to claim 26, which comprises using a residence time at the position to determine whether the position is a parked position.

28. The person guidance method according to claim 26, which comprises finding a motor vehicle that has been parked in a parking garage, and thereby using map information from a digital map of the parking garage.

29. The person guidance method according to claim 26, wherein the transmitting device is integrated in an identity card, and the method comprising reading an identity code on the identity card in order to identify the transmitting device, and assigning the identity code to the identifier of the emitted signal.

30. The person guidance method according to claim 29, wherein the identity card is transferred to a motor vehicle driver upon driving into a parking garage.
